(19) United States
(12) Patent Application Publication
(10) Pub. No.: US 2013/0180854 A1
(43) Pub. Date: Jul. 18, 2013

(54) CORRECTION COEFFICIENT SETTING METHOD OF GAS CONCENTRATION DETECTION APPARATUS, GAS CONCENTRATION DETECTION APPARATUS AND GAS SENSOR

(71) Applicant: NGK SPARK PLUG CO., LTD., Nagoya (JP)

(72) Inventor: Hisashi SASAKI, Konan-shi (JP)

(73) Assignee: NGK SPARK PLUG CO., LTD., Nagoya, Aichi (JP)

(21) Appl. No.: 13/742,475

(22) Filed: Jan. 16, 2013

(30) Foreign Application Priority Data
Jan. 17, 2012 (JP) 2012-006754

(51) Int. Cl. G01N 27/416

(52) U.S. Cl. CPC G01N 27/4162
USPC 204/407

(57) ABSTRACT

A method of setting a correction coefficient for correcting an oxygen concentration detected by a gas concentration detection apparatus, the method including the steps of obtaining a current value of current flowing in an oxygen pump cell of a gas sensor by exposing the gas sensor device to each of at least three or more sample gases of different known oxygen concentrations; calculating, after a corrected oxygen concentration is calculated using the current value and a correction value, a correction coefficient approximating a linear relationship between any one corrected oxygen concentration serving as a reference and two other corrected oxygen concentrations. Also disclosed is a gas concentration detection apparatus including a gas sensor device, a calculation means and a memory means for storing the correction coefficient obtained in accordance with the method.

### BACKGROUND OF THE INVENTION

1. Field of the Invention

The present invention relates to a method for setting a correction coefficient of a gas concentration detection apparatus which detects an oxygen concentration of a gas subject to detection, a gas concentration detection apparatus and a gas sensor.

2. Description of the Related Art

A gas sensor has been known which outputs a concentration signal in accordance with the concentration of a specific gas among gases subject to detection. In general, the gas sensor is provided in a flow pipe (for example, an exhaust pipe) through which gases subject to detection flow for connection to a gas concentration detection apparatus (for example, a sensor control device) disposed outside the flow pipe. The gas concentration detection apparatus performs various controls with respect to the gas sensor, such as supplying electric current to the gas sensor and controlling a voltage applied to a heater to heat the gas sensor to obtain a concentration signal from the gas sensor.

However, in terms of a characteristic (hereinafter, referred to as an “output characteristic”) indicating a relationship between the concentration of a specific gas and the concentration signal value output from the gas sensor, a case occurs where each gas sensor outputs slightly different values. For example, in each of a plurality of gas sensors, the output characteristic thereof may vary due to manufacturing variations. In this regard, the sensor control apparatus (the gas concentration detection apparatus) disclosed in JP-A-2011-53032 corrects the corresponding value of the gas concentration output from a gas sensor when the gas sensor is activated. Specifically, in JP-A-2011-53032, the sensor control apparatus stores a plurality of kinds of pattern data as correction data, which data indicates patterns of change in gas concentration corresponding values with the passage of time, applies appropriate correction data to individual gas sensors, and corrects the output of the gas sensor when the gas sensor is activated.

However, in JP-A-2011-53032, when correction of the output of the gas sensor is performed by applying correction data, the CPU of the gas concentration detection apparatus has a high calculation load. When oxygen is used as the specific gas, a quadratic function is known to have been used to express the relationship between oxygen concentration and the concentration signal value. This is shown as a graph drawn as a curve with an axis of the oxygen concentration and an axis of the concentration signal value. Consequently, in the gas concentration detection apparatus used to detect oxygen concentration, if the oxygen concentration is obtained by correcting the concentration signal value of the gas sensor using a relationship formula expressed as a quadratic function, it is possible to reduce the calculation load as compared to the case of using correction data.

However, there is a need to further reduce the load in the CPU of a gas concentration detection apparatus.

### SUMMARY OF THE INVENTION

The present invention has been made to solve the above problem, and an object thereof is to provide a correction coefficient setting method of a gas concentration detection apparatus, a gas concentration detection apparatus and a gas sensor, in which an output characteristic is corrected using a correction coefficient to approximate the relationship between an oxygen concentration and a concentration signal value with a straight line. In this manner, the oxygen concentration in accordance with the concentration signal value can be obtained by a simple calculation.

According to a first aspect, the present invention provides a method of setting a correction coefficient for correcting an oxygen concentration detected by a gas concentration detection apparatus, which correction coefficient is determined in advance of detecting a gas concentration, the gas concentration detecting apparatus comprising a gas sensor device having at least two or more cells each having a pair of electrodes and a solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber; calculation means for calculating an oxygen concentration of the gas subjected to detection based on a current flowing in the oxygen pump cell by feedback control in accordance with a voltage generated in the oxygen partial concentration detection cell; and memory means for storing a correction coefficient used for correcting a current value of a current flowing in the oxygen pump cell when the calculation means calculates the oxygen concentration, the method comprising: obtaining a current value of current flowing in the oxygen pump cell by exposing the gas sensor device to each of at least three or more sample gases of different known oxygen concentrations; calculating, after a corrected oxygen concentration is calculated using the current value and a correction value correcting a variation due to individual differences among gas sensor devices, a correction coefficient approximating a linear relationship between any one corrected oxygen concentration serving as a reference and two other corrected oxygen concentrations; and storing the calculated correction coefficient in the memory means.

In the first aspect, an approximate linear relationship is established in advance between any one corrected oxygen concentration serving as a reference and two other corrected oxygen concentrations to obtain a correction coefficient that is used to calculate oxygen concentration, thereby further improving detection accuracy of oxygen concentration as compared to the case where the relationship between oxygen concentration and concentration signal value is defined by the curve of a quadratic function in the related art. Especially, it is possible to improve the detection accuracy at low oxygen concentrations. In addition, the correction coefficient is stored in the memory means of the gas concentration detection apparatus, thereby performing correction for individual gas sensor devices and improving detection accuracy of the oxygen concentration. Moreover, the calculation for correcting the oxygen concentration can be easily performed using a linear function, thereby lowering the load placed on the calculation means.

According to a second aspect, the present invention provides a gas concentration detection apparatus comprising: a gas sensor device having at least two or more cells each having a pair of electrodes and a solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber; calculation means for calculating an oxygen concentration of the gas subjected to detection based on the current flowing in the oxygen pump cell by feedback control in accordance with a voltage generated in the oxygen partial concentration detection cell; and memory means for storing a correction coefficient k used for correcting a current value of a current flowing in the oxygen pump cell when the calculation means calculates the oxygen concentration, wherein the correction coefficient k is obtained by means of, obtaining a current value of current flowing in the oxygen pump cell by exposing the gas sensor device to each of at least three or more sample gases of different known oxygen concentrations, calculating, after a corrected oxygen concentration is calculated using the current value and a correction value correcting a variation due to individual differences among gas sensor devices, the correction coefficient k approximating a linear relationship between any one corrected oxygen concentration serving as a reference and two other corrected oxygen concentrations.

In the second aspect, an approximate linear relationship is established in advance between any one corrected oxygen concentration serving as a reference and two other corrected oxygen concentrations to obtain a correction coefficient that is used to calculate oxygen concentration, thereby further improving detection accuracy of oxygen concentration as compared to the case where the relationship between oxygen concentration and concentration signal value is defined by the curve of a quadratic function in the related art. Especially, it is possible to improve the detection accuracy at low oxygen concentrations. In addition, the correction coefficient is stored in the memory means of the gas concentration detection apparatus, thereby performing correction for individual gas sensor devices and improving detection accuracy of the oxygen concentration. Moreover, the calculation for correcting the oxygen concentration can be easily performed using a linear function, thereby lowering the load placed on the calculation means.

According to a third aspect, the present invention provides a gas sensor device having at least two or more cells each having a pair of electrodes and a solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber; and memory means for storing a correction coefficient used for correcting a current value of a current flowing in the oxygen pump cell, wherein the gas sensor is connected to a calculation means for calculating an oxygen concentration of the gas subjected to detection based on a current flowing in the oxygen pump cell by feedback control in accordance with a voltage generated in the oxygen partial concentration detection cell, and wherein the correction coefficient is obtained by means of, obtaining a current value of current flowing in the oxygen pump cell by exposing the gas sensor device to each of at least three or more sample gases of different known oxygen concentrations, calculating, after a corrected oxygen concentration is calculated using the current value and a correction value correcting a variation due to individual differences among gas sensor devices, the correction coefficient approximating a linear relationship between any one corrected oxygen concentration serving as a reference and two other corrected oxygen concentrations.

In the third aspect, an approximate linear relationship is established in advance between any one corrected oxygen concentration serving as a reference and two other corrected oxygen concentrations to obtain a correction coefficient that is used to calculate oxygen concentration, thereby further improving detection accuracy of oxygen concentration as compared to the case where the relationship between oxygen concentration and concentration signal value is defined by the curve of a quadratic function in the related art. Especially, it is possible to improve the detection accuracy at low oxygen concentrations. In addition, a correction coefficient is stored in the memory means of the gas sensor, thereby performing correction for individual gas sensors and improving detection accuracy of the oxygen concentration. Moreover, the calculation for correcting the oxygen concentration can be easily performed using a linear function, thereby lowering the load placed on the calculation means.

### BRIEF DESCRIPTION OF THE DRAWINGS

FIG. 1 is a conceptual view illustrating a gas concentration detection apparatus 1; and

FIG. 2 is an example of a graph used to obtain a correction coefficient for approximating an output characteristic with a linear function, where the output characteristic is shown by any one corrected oxygen concentration serving as a reference and two other corrected oxygen concentrations.

### DETAILED DESCRIPTION OF THE INVENTION

Hereinafter, an embodiment of the present invention will be described with reference to the accompanying drawings. The accompanying drawings are used for explaining the technical characteristics of the configurations employed by the present invention, in which the configurations of devices are only examples, but should not be construed as being limited thereto.

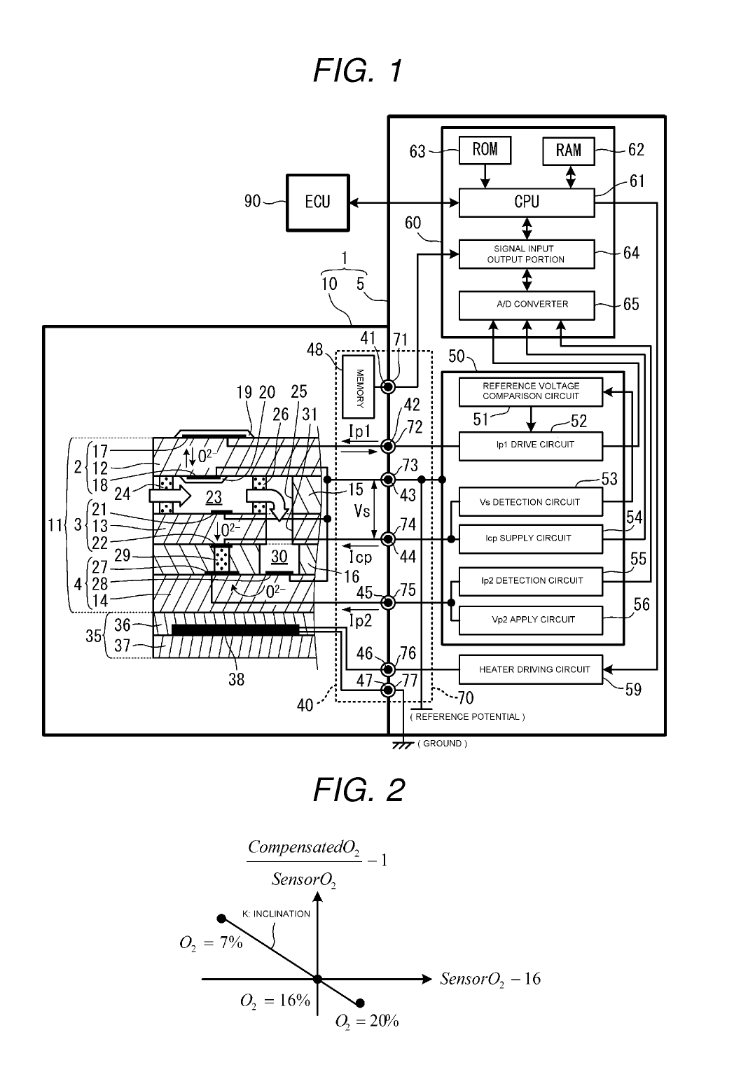

First, the configuration of a gas concentration detection apparatus 1 will be described which performs correction of the output of a gas sensor 10 using a correction coefficient obtained in advance by a correction coefficient setting method according to the present invention, referring to FIG. 1. The gas concentration detection apparatus 1 has a function of detecting oxygen concentration.

As shown in FIG. 1, the gas concentration detection apparatus 1 has a gas sensor 10 and a controller 5. The gas sensor 10 is installed in an exhaust path (not shown) of a vehicle, and outputs a current value in accordance with an oxygen concentration and a NOx concentration in the exhaust gas to the controller 5. The controller 5 is electrically connected with the gas sensor 10 to calculate a concentration corresponding value indicating an oxygen concentration and an NOx concentration in the exhaust gas based on the current value output from the gas sensor 10 as well as to control the gas sensor 10.

First, the gas sensor 10 will be described. The gas sensor 10 includes a detection device 11, a heater device 35, a connector portion 40 and a housing (not shown). The detection device 11 has a configuration in which three plate-shaped solid electrolytes 12, 13 and 14 and two plate-shaped insulators 15 and 16 made of alumina or the like are alternatively laminated. A heater device 35 is laminated on the solid electrolyte 14 in order to rapidly activate a first oxygen pump cell 2, an oxygen partial concentration detection cell 3 and a second oxygen pump cell 4 described below, and to maintain activation stability of the first oxygen pump cell 2, the oxygen partial concentration detection cell 3 and the second oxygen pump cell 4. The connector portion 40 is provided to electrically connect the gas sensor 10 and the controller 5. The housing holds the detection device 11 and the heater device 35 inside thereof for installation of the gas sensor 10 in the exhaust passage (not shown). Also, the detection device 11 corresponds to “a gas sensor device” in the present invention.

Hereinafter, each component of the detection device 11 will be described. The detection device 11 includes a first measurement chamber 23, a second measurement chamber 30, a reference oxygen chamber 29, the first oxygen pump cell 2 (hereinafter referred to as “Ip1cell 2”), the oxygen partial concentration detection cell 3 (hereinafter referred to as “Vscell 3”) and the second oxygen pump cell 4 (hereinafter referred to as “Ip2cell 4”).

The first measurement chamber 23 is provided in a leading edge portion of the detection device 11, and the first measurement chamber 23 is a small space in which exhaust gas inside of the exhaust passage is initially introduced to the detection device 11. The first measurement chamber 23 is formed in the insulator 15 disposed between the solid electrolyte 12 and the solid electrolyte 13. An electrode 18 is disposed on the solid electrolyte 12 side so as to face the first measurement chamber 23, and an electrode 21 is disposed on the solid electrolyte 13 side so as to face the first measurement chamber 23. A first diffusion resistor portion 24 is provided in an opening portion which is open on the leading edge side in the detection device 11 of the first measurement chamber 23. The first diffusion resistor portion 24 defines a compartment between inside and outside of the first measurement chamber 23 and functions to restrict the amount of exhaust gas flowing to the inside of the first measurement chamber 23 per unit time. Similarly, a second diffusion resistor portion 26 is provided on the back edge side in the detection device 11 of the first measurement chamber 23. The second diffusion resistor portion 26 defines a compartment between the first measurement chamber 23 and the second measurement chamber 30 and functions to restrict the amount of gas flowing from the first measurement chamber 23 to the inside of the second measurement chamber 30 per unit time.

The second measurement chamber 30 is a small space surrounded by the solid electrolyte 12, the second diffusion resistor portion 26 and the opening portion 25, the opening portion 31 provided in the solid electrolyte 13, the insulator 16 and an electrode 28. The second measurement chamber 30 is in communication with the first measurement chamber 23. Thus, after the oxygen concentration is adjusted by the Ip1cell 2, the exhaust gas (hereinafter referred to as an “adjusted gas”) is introduced thereto. The reference oxygen chamber 29 is a small space surrounded by the insulator 16, an electrode 22 and an electrode 27. The inside of the reference oxygen chamber 29 is filled with a porous material made of ceramic.

The Ip1cell 2 includes the solid electrolyte 12 and porous electrodes 17 and 18. The solid electrolyte 12 is made of, for example, zirconia, and has oxygen ion conductivity. The electrodes 17 and 18 are provided on opposing sides of the solid electrolyte 12 in the layered direction of the detection device 11. The electrodes 17 and 18 are made of a material mainly containing Pt. Examples of the material mainly containing Pt include Pt, a Pt alloy, and a cermet including Pt and ceramic. In addition, porous protection layers 19 and 20 made of ceramic are formed on the surfaces of the electrodes 17 and 18, respectively.

The Ip1cell 2 supplies a current between electrodes 17 and 18, thus pumping oxygen in and out (so-called oxygen pumping) between the atmosphere in contact with the electrode 17 (the atmosphere outside the detection device 11) and the atmosphere in contact with the electrode 18 (the atmosphere inside the first measurement chamber 23).

The Vscell 3 includes the solid electrolyte 13 and porous electrodes 21 and 22. The solid electrolyte 13 is made of, for example, zirconia, and has oxygen ion conductivity. The solid electrolyte 13 is disposed to face the solid electrolyte 12 with the insulator 15 interposed therebetween. The electrodes 21 and 22 are provided on opposing sides of the solid electrolyte 13 in the layered direction of the detection device 11, respectively. The electrode 21 is formed on the side facing the solid electrolyte 12 inside the first measurement chamber 23. The electrodes 21 and 22 are made of the above mentioned material mainly containing Pt.

The Vscell 3 mainly generates an electromotive force in accordance with an oxygen concentration difference between the atmospheres separated by the solid electrolyte 13 (the atmosphere inside the first measurement chamber 23 in contact with the electrode 21 and the atmosphere inside the reference oxygen chamber 29 in contact with the electrode 22). The Vscell 3 controls the atmosphere inside of the reference oxygen chamber 29 to establish a reference oxygen concentration.

The Ip2cell 4 includes the solid electrolyte 14 and porous electrodes 27 and 28. The solid electrolyte 14 is made of, for example, zirconia, and has oxygen ion conductivity. The solid electrolyte 14 is disposed to face the solid electrolyte 13 with the insulator 16 interposed therebetween. The electrodes 27 and 28 which are made of the above mentioned material mainly containing Pt are each provided on the solid electrolyte 14 so as to face the solid electrolyte 13.

The Ip2cell 4 pumps out oxygen between the atmospheres separated by the insulator 16 (the atmosphere inside the reference oxygen chamber 29 in contact with the electrode 27 and the atmosphere inside the second measurement chamber 30 in contact with the electrode 28).

The following is a description of the heater device 35. The heater device 35 includes insulating layers 36 and 37, and a heater pattern 38. The insulating layers 36 and 37 have sheet-like shapes mainly containing alumina. The heater pattern 38 is buried between the insulating layers 36 and 37, and has an integral electrode pattern which extends inside the heater device 35. In the heater pattern 38, the edge of the one side is grounded, and the edge of the other side is connected to a heater driving circuit 59. The heater pattern 38 is made of a material mainly containing Pt.

The following is a description of the connector 40. Since the configuration of the connector 40 has a known configuration such as that disclosed in JP-A-2009-121975, a detailed explanation thereof is omitted. The connector 40 is provided on the back edge side of the gas sensor 10, and has a connector main portion and a casing portion fixed to the connector main portion. Terminals 41 to 47 are disposed inside of the connector main portion and a memory 48 is provided inside the casing portion. The memory 48 is, for example, a semiconductor storage medium. The memory 48 stores the correction coefficient obtained in advance by a method of setting a correction coefficient described below. The terminal 41 is connected to the memory 48. The terminal 42 is connected to the electrode 17 through a lead wire. The terminal 43 is connected to the electrodes 18, 21 and 28 through a lead wire. The terminal 44 is connected to the electrode 22 through a lead wire. The terminal 45 is connected to the electrode 27 through a lead wire. The electrodes 46 and 47 are connected to both edges of a heater pattern 38 through a lead wire, respectively. Also, the memory 48 corresponds to the “memory means” in the present invention.

Next, the configuration of the controller 5 will be explained. The controller 5 is an apparatus which controls the detection device 11 and the heater device 35. Also, the controller 5 calculates an oxygen concentration corresponding value based on the Ip1 current obtained from the detection device 11 and calculates an NOx concentration corresponding value based on the Ip2 current obtained from the detection device 11, so as to output a calculated oxygen concentration corresponding value and a calculated NOx concentration corresponding value to an ECU 90. The controller 5 is equipped with a control circuit portion 50, a microcomputer 60 and a connector portion 70. The control circuit portion 50 controls the detection device 11 and the heater device 35. The microcomputer 60 controls the control circuit portion 50. The connector portion 70 is electrically connected to the connector portion 40 of the gas sensor 10. The components of the controller 5 are described as follows.

The control circuit portion 50 includes a reference voltage comparison circuit 51, an Ip1 drive circuit 52, a Vs detection circuit 53, an Icp supply circuit 54, a Ip2 detection circuit 55, a Vp2 apply circuit 56 and a heater driving circuit 59. Each circuit operates in accordance with a control signal from the microcomputer 60. The following is a description of the components constituting the control circuit portion 50.

The Icp supply circuit 54 supplies a weak current Icp between the electrodes 21 and 22 of the Vscell 3 to transport oxygen ion from the first measurement chamber 23 to the inside of the reference oxygen chamber 29, to thereby introduce oxygen into the reference oxygen chamber 29. The Vs detection circuit 53 detects a voltage (an electromotive force) Vs between the electrodes 21 and 22, and outputs the detection result to the reference voltage comparison circuit 51. The reference voltage comparison circuit 51 compares the voltage Vs detected by the Vs detection circuit 53 with a reference voltage (for example, 425 mV), and outputs the comparison result to the Ip1 drive circuit 52.

The Ip1 drive circuit 52 supplies a pump current Ip1 between the electrodes 17 and 18 of the Ip1 cell 2. The Ip1 drive circuit 52 controls the size and the direction of the pump current Ip1 based on the comparison result of the voltage Vs between the electrodes 21 and 22 of the Vscell 3 as carried out by the reference voltage comparison circuit 51 such that the voltage Vs approximately coincides with the predetermined reference voltage. As a result, the Ip1cell 2 pumps out oxygen from the inside of the first measurement chamber 23 to the outside of the detection device 11 or pumps in oxygen from the outside of the detection device 11 to the inside of the first measurement chamber 23. In other words, in the Ip1cell 2, the oxygen concentration inside of the first measurement chamber 23 is adjusted based on power control by the Ip1 drive circuit 52 to keep the voltage between the electrodes 21 and 22 of the Vscell 3 at a constant value (the value of the reference voltage).

The Ip2 detection circuit 55 detects the value of the current Ip2 flowing from the electrode 28 to the electrode 27 of the Ip2cell 4. A Vp2 apply circuit 56 applies a normal voltage Vp2 (for example, 450 mV) between the electrodes 27 and 28 of the Ip2cell 4 and controls pumping out of oxygen from the inside of the second measurement chamber 30 to the reference oxygen chamber 29.

A heater driving circuit 59 keeps the Ip1cell 2, the Vscell 3 and the Ip2cell 4 at a predetermined temperature. The heater driving circuit 59 is controlled by the microcomputer 60 to supply a current to the heater pattern 38 of the heater device 35 and heat the Ip1cell 2, the Vscell 3 and the Ip2cell 4. The heater driving circuit 59 can control the supply of current to the heater pattern 38 by applying power in a PWM mode so that the temperature of the heater assumes a target temperature.

The microcomputer 60 is a calculation device equipped with a CPU 61, a ROM 63, a RAM 62, a signal input output portion 64 and an A/D converter 65 that are publicly known. The microcomputer 60 outputs a control signal to the control circuit portion 50 according to programs installed in advance therein to control an operation of each circuit with which the control circuit portion 50 is equipped. The ROM 63 stores various programs, various parameters that are referred to when running the programs, and the like. The microcomputer 60 communicates with the ECU 90 to control an internal combustion (not shown) through a signal input output portion 64 and communicates with the control circuit portion 50 through the A/D converter 65 and the signal input output portion 64.

The connector portion 70 includes terminals 71 to 77. When the connector portion 70 is connected to the connector portion 40, the terminals 71 to 77 are connected to the terminals 41 to 47, respectively. The terminal 71 is connected to the signal input output portion 64 through a lead wire. The terminal 72 is connected to the Ip1 drive circuit 52 through a lead wire. The terminal 73 is connected to the reference potential through a lead wire. The terminal 74 is connected to the Vs detection circuit 53 and the Icp supply circuit 54 through a lead wire. The terminal 75 is connected to the Ip2 detection circuit 55 and the Vp2 apply circuit 56 through a lead wire. The terminal 76 is connected to the heater driving circuit 59 through a lead wire. The terminal 77 is grounded through a lead wire.

Next, operation of the gas concentration detection apparatus 1 will be described when detecting oxygen concentration and NOx concentration in the exhaust gas. The exhaust gas flowing through the exhaust path (not shown) is introduced into the first measurement chamber 23 through the first diffusion resistor portion 24. In the Vscell 3, a weak current Icp is supplied from the electrode 22 side to the electrode 21 side by the Icp supply circuit 54. Therefore, oxygen in the exhaust gas becomes oxygen ion which flows from the electrode 21 that is a negative electrode to the inside of the solid electrolyte 13 and moves inside the reference oxygen chamber 29 on the electrode 22 side of the solid electrolyte 13. That is, a current Icp is supplied between the electrodes 21 and 22. Thus, oxygen inside of the first measurement chamber 23 is transported to the inside of the reference oxygen chamber 29 and collects therein.

In the Vs detection circuit 53, the voltage Vs between the electrodes 21 and 22 is detected. The detected voltage Vs is compared with the reference voltage (for example, 425 mV) using the reference voltage comparison circuit 51, and the comparison result is output to the Ip1 drive circuit 52. In the Ip1 drive circuit 52, the size and the direction of the pump current Ip1 flowing between the electrodes 17 and 18 of the Ip1 cell are controlled such that the electromotive force Vs becomes the reference voltage, based on the comparison result by the reference voltage comparison circuit 51. Here, if the oxygen concentration inside of the first measurement chamber 23 is adjusted such that the potential difference between the electrodes 21 and 22 assumes a given value in the vicinity of the reference voltage, the oxygen concentration of the exhaust gas inside of the first measurement chamber 23 is in the vicinity of the predetermined concentration C (for example, 0.001 ppm).

Consequently, in the case where the oxygen concentration of the exhaust gas introduced to the inside of the first measurement chamber 23 is lower than the concentration C, the drive circuit 52 supplies pump current Ip1 to the Ip1cell 2 such that the electrode 17 becomes a negative. As a result, in the Ip1cell 2, oxygen is pumped in from the outside of the detection device 11 to the inside of the first measurement chamber 23. On the other hand, in the case where the oxygen concentration of the exhaust gas introduced to the inside of the first measurement chamber 23 is higher than the concentration C, the Ip1 drive circuit 52 supplies the pump current Ip1 to the Ip1cell 2 such that the electrode 18 becomes negative. As a result, in the Ip1cell 2, oxygen is pumped out from the first measurement chamber 23 to the outside of the detection device 11. At this time, the pump current Ip1 is output to the microcomputer 60 as the oxygen concentration output (an oxygen concentration signal) of the gas sensor 10. The microcomputer 60 detects the oxygen concentration contained in the exhaust gas and the air fuel ratio of the exhaust gas from the magnitude and direction of the value of the pump current Ip1, to output the detected value to the ECU 90.

In the first measurement chamber 23, the adjusted gas having an adjusted oxygen concentration C is introduced into the inside of the second measurement chamber 30 through the second diffusion resistor portion 26. Inside of the second measurement chamber 30, NOx in the adjusted gas which contacts the electrode 28 is decomposed (reduced) into N₂ and O₂ with the electrode 28 serving as a catalyst. The decomposed oxygen is converted to oxygen ion (disassociated) by receiving an electron from the electrode 28, and the oxygen ion is transported through the solid electrolyte 14 to the inside of the reference oxygen chamber 29. At this time, the value of the current Ip2 flowing between the electrode pair 27 and 28 through the solid electrolyte 14 corresponds to the NOx concentration, and the current Ip2 is output to the microcomputer 60 as the NOx concentration output (an NOx concentration signal) of the gas sensor 10. The microcomputer 60 detects the NOx concentration contained in the exhaust gas from the magnitude of the current Ip2 to output the detected NOx concentration to the ECU 90.

A variance due to individual differences among detection devices occurs in the output characteristic (a characteristic expressing a relationship between an oxygen concentration and a concentration signal value) of the gas sensor 10. The gas concentration detection apparatus 1 calculates a corrected oxygen concentration using the value of the pump current Ip1 output by the detection device 11 and the correction coefficient which is obtained in advance and stored in the memory 48 by the method described below. Then, in order to simplify the calculation for correcting the corrected oxygen concentration, where the correction coefficients for approximating the output characteristic expressed as a quadratic function (curve) in the related art are replaced with a straight line, the graph of a linear function is obtained in advance using the method of setting a correction coefficient described below.

First, the following is a description of steps for drawing a correction coefficient approximating the output characteristic of the detection device 11 with a straight line graph of a linear function. The detection device 11 of the gas sensor 10 outputs the pump current Ip1 based on the oxygen concentration in the exhaust gas. Before the output characteristic is corrected, in the present embodiment, a variation in gain due to an individual difference for each gas sensor 10 is corrected by Equation (1).

SensorO₂=(a value of a pump current Ip1)×(a corrected gain value)×(16 [%]/2.59 [mA]) (1)

The value “SensorO₂” is the corrected oxygen concentration based on the value of the pump current Ip1 output by each gas sensor 10. In order to simplify the calculation, the correction coefficient described below is derived from a straight line, which is the graph of a linear function passing through the origin when the oxygen concentration of 16% is set as a reference. For example, when the oxygen concentration is 16%, a value of the pump current Ip1 output by the gas sensor serving as a reference (Master Sensor) is 2.59 mA. Equation (1) corrects the gain of the pump current Ip1 value by applying a gain correction value such that the oxygen concentration obtained in the case where the gas sensor 10 to be corrected is exposed to a sample gas whose oxygen concentration is adjusted to 16% becomes 16% without depending on individual differences among gas sensors 10. Concretely, the gain correction value is calculated for each gas sensor 10 based on the value of the pump current Ip1 obtained by exposing the gas sensor 10 to the sample gas whose oxygen concentration is adjusted to 16%. In the case of the reference gas sensor, the gain correction value is “1.”

Then, a correction coefficient approximating a linear (straight line) relationship, between any one corrected oxygen concentration that serves as a reference and two other corrected oxygen concentrations, is obtained. As described above, the relationship between the oxygen concentration and the value of the pump current Ip1 is normally expressed as a curve, namely, the graph of a quadratic function. Thus, if SensorO₂ is approximated with a quadratic function of any variable “x” which passes through the origin, SensorO₂ can be expressed as Equation (2). Where, a<<1, b˜1.

SensorO₂=ax²+bx (2)

In addition, in terms of a coefficient “c(x)” which depends on x, if “CompensatedO₂” is approximated with the linear function of SensorO₂ passing through the origin, it is expressed as Equation (3).

CompensatedO₂=c(x)·SensorO₂ (3)

By substituting Equation (2) into Equation (3), Equation (4) is obtained.

CompensatedO₂=c(x)·(ax²+bx) (4)

Here, if CompensatedO₂ is assumed to be a linear function of the variable x passing through the origin by taking the coefficient as 1, Equation (5) is obtained.

CompensatedO₂=x (5)

By means of Equations (4) and (5), the following is obtained.

$$\begin{matrix}[ Formula 1 ] & \\ c ( x ) = \frac{x}{{ax}^{2} + bx} = \frac{1}{ax + b} & ( 6 )\end{matrix}$$

Meanwhile, if SensorO₂ is changed and substituted into Equation (2), the following is obtained.

$$\begin{matrix}[ Formula 2 ] & \\ \begin{matrix}{SensorO}_{2} = \frac{4 a}{4 a} \cdot {SensorO}_{2} + \frac{{b}^{2} - {b}^{2}}{4 a} \\ = \frac{4 a \cdot ( {ax}^{2} + bx ) + {b}^{2} - {b}^{2}}{4 a} \\ = \frac{{( 2 ax + b )}^{2} - {b}^{2}}{4 a}\end{matrix} & ( 7 )\end{matrix}$$

If Equation (7) is developed, x is obtained as follows.

$$\begin{matrix}[ Formula 3 ] & \\ x = \frac{- b + \sqrt{4 a \cdot {SensorO}_{2} + {b}^{2}}}{2 a} & ( 8 )\end{matrix}$$

If Equation (8) is substituted into Equation (6), Equation (9) is obtained.

$$\begin{matrix}[ Formula 4 ] & \\ \begin{matrix}c ( x ) = \frac{1}{a \cdot \frac{- b + \sqrt{4 a \cdot {SensorO}_{2} + {b}^{2}}}{2 a} + b} \cdot \frac{\frac{2}{b}}{\frac{2}{b}} \\ = \frac{2}{b} \cdot \frac{1}{1 + \sqrt{1 + \frac{4 a}{{b}^{2}} \cdot {SensorO}_{2}}}\end{matrix} & ( 9 )\end{matrix}$$

Here, if Equation (9) is developed using the approximation equation “1+α˜1+α/2”, the following is obtained.

$$\begin{matrix}[ Formula 5 ] & \\ c ( x ) \sim \frac{1}{b} \cdot \frac{1}{1 + \begin{matrix}a \\ {b}^{2}\end{matrix} \cdot {SensorO}_{2}} & ( 10 )\end{matrix}$$

Further, if Equation (10) is developed using the approximation equation “1/(1+α)˜1−α”, the following is obtained.

$$\begin{matrix}[ Formula 6 ] & \\ \begin{matrix}c ( x ) \sim \frac{1}{b} ( 1 - \frac{a}{{b}^{2}} \cdot {SensorO}_{2} ) \\ = \frac{1}{b} - \frac{a}{{b}^{3}} ( {SensorO}_{2} - 16 + 16 ) \\ = \frac{a}{{b}^{3}} ( {SensorO}_{2} - 16 ) + \frac{1}{b} - 16 \frac{a}{{b}^{3}}\end{matrix} & ( 11 )\end{matrix}$$

If (16a+b) is taken to be approximately 1 based on a<<1, b˜1, and Equation (11), the following is obtained.

$$\begin{matrix}[ Formula 7 ] & \\ \begin{matrix}c ( x ) \sim - \frac{a}{{b}^{3}} ( {SensorO}_{2} - 16 ) + \frac{1}{b} - \frac{1 - b}{{b}^{3}} \\ = - \frac{a}{{b}^{3}} ( {SensorO}_{2} - 16 ) + \frac{1}{b} + \frac{1}{{b}^{2}} - \frac{1}{{b}^{3}}\end{matrix} & ( 12 )\end{matrix}$$

In addition, Equation (12) is developed based on a<<1, b˜1, where, k=−a/b³.

$$\begin{matrix}[ Formula 8 ] & \\ \begin{matrix}c ( x ) \sim - \frac{a}{{b}^{3}} ( {SensorO}_{2} - 16 ) + \frac{1}{1} + \frac{1}{{1}^{2}} - \frac{1}{{1}^{3}} \\ = k ( {SensorO}_{2} - 16 ) + 1\end{matrix} & ( 13 )\end{matrix}$$

When c(x) of Equation (13) is introduced into Equation (3),

CompensatedO₂={k(SensorO₂−16)+1}·SensorO₂ (14)

By rearranging Equation (14), the following is obtained.

$$\begin{matrix}[ Formula 9 ] & \\ \frac{{CompensatedO}_{2}}{{SensorO}_{2}} - 1 = k ( {SensorO}_{2} - 16 ) & ( 15 )\end{matrix}$$

According to Equation (15), as shown in FIG. 2, the corrected oxygen concentration (SensorO₂) of 16% is set as the reference of the corrected oxygen concentration. Thus, a straight line graph of a linear function is obtained which passes through the origin and whose inclination (slope) is “k.” The “k” is the correction coefficient obtained in the present embodiment. If the correction coefficient k for each gas sensor 10 is obtained, using Equation (14), CompensatedO₂ can be obtained from the corrected oxygen concentration (SensorO₂) by gain correction of the value of the pump current Ip1 according to the respective individual differences by a simple calculation.

In addition, in correcting the CompensatedO₂ output of each gas sensor 10, the correction coefficient k may be obtained in order to match the oxygen concentration obtained as an output from the gas sensor serving as a reference (Master Sensor). Specifically, in the manufacturing process of the gas sensor 10, the correction coefficient k is obtained in advance and is stored in the memory 48 by the following steps.

Sample gases each set to three or more different known oxygen concentrations are prepared, and the gas sensor 10 to be corrected is exposed thereto. The known oxygen concentrations are based on the oxygen concentration measured by the master sensor. For each oxygen concentration, the value of the pump current Ip1 output by the gas sensor 10 is acquired (acquisition process). In the present embodiment, the values of the pump currents Ip1 are obtained at three points where the oxygen concentrations are 7%, 16% and 20%.

Each value of the pump current Ip1 thus obtained is substituted into equation (1), and the corrected oxygen concentration (SensorO₂) is obtained. Based on Equation (15), a straight line most adjacent to each of the above three points temporarily plotted in the graph with an axis of “(CompensatedO₂/SensorO₂)−1” and an axis of “SensorO₂−16” is obtained. Specifically, this straight line may be calculated using known means such as, for example, a least square method. Also, the slope of the straight line thus obtained is calculated as the correction coefficient k (calculation process).

The calculated correction coefficient k is stored in the memory 48 (memory process). Also, the gain correction value of Equation (1) is stored in the memory 48. Equations (1) and (14) are stored in ROM 63 with which the microcomputer 60 of the controller 5 is equipped (memory process).

When the gas concentration detection apparatus 1 detects the oxygen concentration in the exhaust gas, the CPU 61 reads the gain correction value and the correction coefficient k from the memory 48. As described above, the pump current Ip1 is obtained from the gas sensor 10, and based on the value thus obtained, SensorO₂ is calculated using Equation (1). Then, the obtained SensorO₂ and the obtained correction coefficient k are substituted into Equation (14), to thereby calculate CompensatedO₂. The calculated CompensatedO₂ is output to the ECU 90.

As described above, according to the gas concentration detection apparatus 1 of the present embodiment, using the correction coefficient k which is set in advance and used for calculating the oxygen concentration, it is possible to approximate a linear relationship between a corrected oxygen reference concentration and two other corrected oxygen concentrations,. As a result, it is possible to further improve the detection accuracy of oxygen concentration as compared with the case where the relationship is expressed as a curve, namely, the graph of a quadratic function, in the related art. Specially, it is possible to improving detection accuracy at low oxygen concentration. Further, the correction coefficient k is stored in the memory 48 of each gas oxygen concentration detection apparatus 1 (that is, gas sensor 10), thereby correcting each gas sensor 10 and increasing the detection accuracy of oxygen concentration. In addition, it is possible to easily calculate the oxygen concentration correction using a linear function, thereby reducing the load to the CPU 61.

Also, the present invention is not limited to the aforementioned embodiments. Rather, various modifications may be made within the scope of and without departing from the spirit of the invention. For example, although in the above embodiment the memory 48 is provided in the connector portion 40, it may be provided in any part of the gas sensor 10 such as at any part of the lead wire. Otherwise, a memory may be provided in the controller 5 to store a correction coefficient k, or the ECU 90 may be equipped with a memory storing the correction coefficient k. In such a case, each device in the gas sensor 10 may have an identification number or the like (for example, label attachment using a resistor), and the controller 5 or the ECU 90 may store the correction coefficient k of each gas sensor 10 associated with an identification number. The memory 48 is not limited to a semiconductor storage media, and it may be possible to use means capable of storing a correction coefficient k. For example, a fixed resistor may be used as a memory and a table in which resistance values are associated with values of the correction coefficients k is kept in a ROM 63 of the microcomputer 60. Thus, the value of the correction coefficient k may be obtained from a read-in resistance value.

In addition, the sensor is an NOx sensor in the above embodiment. However, various gas sensors having two cells or more (for example, a full range air fuel ratio sensor) configured with a solid electrolyte can be used as the gas concentration detection apparatus 1.

Further, although in the embodiment the oxygen concentrations of the sample gases to which the gas sensor 10 is exposed in advance are set to 7%, 16% and 20% in order to obtain a correction coefficient k, the oxygen concentration used to obtain the correction coefficient may be, for example, 15% or 18%, or three or more different oxygen concentrations.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application is based on Japanese Patent Application No. 2012-006754 filed Jan. 17, 2012, the disclosure of which is incorporated herein by reference in its entirety.

What is claimed is:

1. A method of setting a correction coefficient for correcting an oxygen concentration detected by a gas concentration detection apparatus, which correction coefficient is determined in advance of detecting a gas concentration,
the gas concentration detection apparatus comprising:
a gas sensor device having at least two or more cells each having a pair of electrodes and a solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber;
calculation means for calculating an oxygen concentration of the gas subjected to detection based on a current flowing in the oxygen pump cell by feedback control in accordance with a voltage generated in the oxygen partial concentration detection cell; and
memory means for storing a correction coefficient used for correcting a current value of a current flowing in the oxygen pump cell when the calculation means calculates the oxygen concentration,
the method comprising:
obtaining a current value of current flowing in the oxygen pump cell by exposing the gas sensor device to each of at least three or more sample gases of different known oxygen concentrations;
calculating, after corrected oxygen concentration is calculated using the current value and a correction value correcting a variation due to individual differences among gas sensor devices, a correction coefficient approximating a linear relationship between any one corrected oxygen concentration serving as a reference and two other corrected oxygen concentrations; and
storing the calculated correction coefficient in the memory means.

2. A gas concentration detection apparatus comprising:
a gas sensor device having at least two or more cells each having a pair of electrodes and solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber;
calculation means for calculating an oxygen concentration of the gas subjected to detection based on the current flowing in the oxygen pump cell by feedback control in accordance with a voltage generated in the oxygen partial concentration detection cell; and
memory means for storing a correction coefficient used for correcting a current value of a current flowing in the oxygen pump cell when the calculation means calculates the oxygen concentration,
wherein, the correction coefficient is obtained by means of, obtaining a current value of current flowing in the oxygen pump cell by exposing the gas sensor device to each of at least three or more sample gases of different known oxygen concentrations, calculating, after a corrected oxygen concentration is calculated using the current value and a correction value correcting a variation due to individual differences among gas sensor devices, the correction coefficient approximating a linear relationship between any one corrected oxygen concentration serving as a reference and two other corrected oxygen concentrations.

3. A gas sensor comprising:
a gas sensor device having at least two or more cells each having a pair of electrodes and a solid electrolyte interposed therebetween, the cells including an oxygen pump cell and an oxygen partial concentration detection cell, the oxygen pump cell pumping oxygen in or out of a measurement chamber in accordance with a current flowing between a pair of first electrodes respectively provided inside and outside the measurement chamber to which a gas subjected to detection is introduced, the oxygen partial concentration detection cell generating a voltage between a pair of second electrodes in accordance with an oxygen concentration of the measurement chamber, and one electrode of the pair of the second electrodes being exposed to the measurement chamber; and
memory means for storing a correction coefficient used for correcting a current value of a current flowing in the oxygen pump cell,
wherein the gas sensor is connected to a calculation means for calculating an oxygen concentration of the gas subjected to detection based on a current flowing in the oxygen pump cell by feedback control in accordance with a voltage generated in the oxygen partial concentration detection cell, and
wherein, the correction coefficient is obtained by means of, obtaining a current value of current flowing in the oxygen pump cell by exposing the gas sensor device to each at least three or more sample gases of different known oxygen concentrations, calculating, after a corrected oxygen concentration is calculated using the current value and a correction value correcting a variation due to individual differences among gas sensor devices, the correction coefficient approximating a linear relationship between any one corrected oxygen concentration serving as a reference and two other corrected oxygen concentrations.
